(19) United States
(12) Patent Application Publication
(10) Pub. No.: US 2023/0144401 A1
(43) Pub. Date: May 11, 2023

(54) ASSEMBLED DEVICE AERATING THE LAWN BY PERFORATING

(71) Applicant: Hangzhou Sinoshine Import & Export Co.,LTD, Hangzhou City (CN)

(72) Inventor: Botu DING, Hangzhou City (CN)

(21) Appl. No.: 17/520,328

(22) Filed: Nov. 5, 2021

(51) Int. Cl. A01B 1/24

(52) U.S. Cl. CPC A01B 1/243

(57) ABSTRACT

The present invention discloses an assembled device aerating the lawn by perforating, applying to the field of garden equipment, comprising a holding part, a ground inserting part and a connecting part connecting the two. The ground inserting part is used for perforating the lawn under the action of down pressure, at least one plug is provided, and the plug is a hard hollow pipe, and the bottom of the hard hollow pipe is an oblique incision with a tip, and the top of the plug is provided with a soil outlet, the inner diameter of the hard hollow pipe gradually increases from the oblique incision to the soil outlet. The present invention can be disassembled as a whole and used by the user's own assembly, which reduces the volume and is more suitable for aerating the small lawn.

### TECHNICAL FIELD

The present invention relates to the field of garden tools, in particular to a device for aerating the lawn.

### BACKGROUND

In the stadium, football field and other sports venues, as well as in the square green space, parks and other leisure sites, a large number of lawns are often laid, even in some family courtyards, lawns are often planted to beautify the environment. However, as the lawn planting time goes by, the soil on the lawn will gradually harden, and the grass growing on the hard soil will not be able to take root easily. And when the soil hardens, even if the grass has taken root, the oxygen and water supply to the root is insufficient, preventing the grass from growing properly. This will cause the lawn not only to expose the bare land and fail to achieve the effect of beautifying the environment, but also more likely to have poor drainage and ponding. This problem can be solved by aerating the lawn.

At present, some large lawns (football fields, greens, etc.) usually use large aerating devices to aerate the lawn, but these devices need to be purchased at a high cost, and their economic cost is high. Moreover, for some small lawns (courtyards, gardens, etc.), the use of large aerating devices is not realistic. Therefore, in order to solve the technical problem of aerating lawns, it is necessary to develop an aerating device with low cost and high convenience suitable for small lawns.

### SUMMARY OF THE INVENTION

The object of the present invention is to solve the problems existing in the prior art and provide an assembled device aerating the lawn by perforating, the device can realize the loosening of the soil and aeration of the soil by perforating the lawn.

The specific technical scheme of the present invention is as follows:

a holding part for the user to hold;

a connecting part, one end is detachably connected and fixed with the holding part, the other end is detachably connected and fixed with a ground inserting part;

a ground inserting part is used for perforating the lawn under the action of down pressure, the ground inserting part is provided with at least one plug, and the plug is a hard hollow pipe, and the bottom of the hard hollow pipe is an oblique incision with a tip, and the top of the plug is provided with a soil outlet, the inner diameter of the hard hollow pipe gradually increases from the oblique incision to the soil outlet.

It should be noted that the orientation of “bottom” and “top” mentioned here is illustrated by the use of the whole device in FIG. 1, but the specific orientation will change when the whole device lies on its side or upside down. This is for convenience only and is not a limitation of the present invention.

Preferably, the holding part is a T-shaped tube composed of a series of horizontal tubes and a series of vertical tubes,

Preferably, the connecting part is a series of straight tubes.

Preferably, detachable connection and fixing forms comprise snap connection, muff coupling, thread connection or connection through detachable connectors.

Preferably, the connecting part comprises two hard steel pipes side by side, and both ends of each hard steel pipe are processed into concave forms, and the two concave surfaces at the same end of the connecting part are opposite to each other, forming a connection structure holding the holding part or the connecting part.

Preferably, the concave surface is provided with connecting holes for screwing into the connectors.

Preferably, the ground inserting part is provided with a trodden part for applying down pressure to the plug.

Preferably, the trodden part is a pedal made of angle steel.

Preferably, the holding part, connecting part and ground inserting part are made of steel.

Preferably, the ground inserting part is provided with two or more plugs.

The device of the present invention is to aerate the soil by perforating the lawn, after perforating, the air can directly enter the depth of the soil and improve the internal environment, at the same time, the holes can also improve the loose degree of the surrounding lawn soil, so as to facilitate drainage and solve various problems caused by the hardening of the lawn soil. The present invention can be disassembled as a whole and used by the user's own assembly, which reduces the volume and is more suitable for aerating the small lawn.

### BRIEF DESCRIPTION OF THE DRAWINGS

FIG. 1 is a schematic diagram of an assembled device aerating the lawn by perforating of the present invention;

FIG. 2 is a schematic diagram of the holding part of a device aerating the lawn by perforating;

FIG. 3 is a schematic diagram of the connecting part of a device aerating the lawn by perforating;

FIG. 4 is a schematic diagram of the ground inserting part of a device aerating the lawn by perforating;

FIG. 5 is a schematic diagram of other forms of the ground inserting part of a device aerating the lawn by perforating, wherein \textcircled{1} is 3 hollow plugs, \textcircled{2} is 4 hollow plugs, \textcircled{3} is 4 solid pointed spikes;

### ATTACHED DRAWINGS MARKS

holding part a, connecting part b, ground inserting part c, handle 1, arc surface 2, pedal 3, plug 4, oblique incision 5, soil outlet 6.

### DESCRIPTION OF EMBODIMENTS

The present invention is further described below in combination with the drawings and specific embodiments. The technical features of each embodiment in the present invention can be combined accordingly on the premise of no conflict.

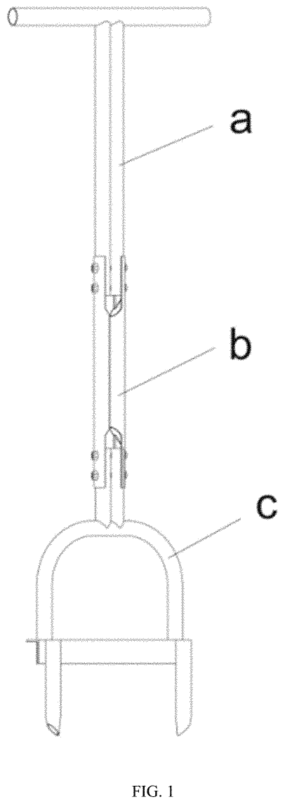

As shown in FIG. 1, the assembled device aerating the lawn by perforating in a better embodiment of the present invention is mainly assembled by three splicing parts, comprising holding part a, connecting part b and ground inserting part c.

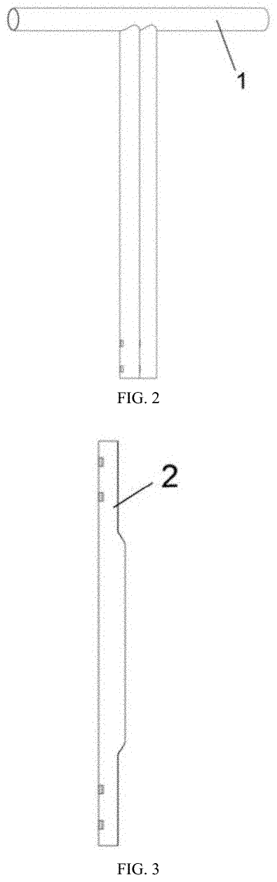

The function of the holding part a is for the user to hold, in this embodiment, its structure adopts T-shaped tube as shown in FIG. 2, which is composed of a series of horizontal tubes and a series of vertical tubes. The two ends of the horizontal tube serve as the handle 1 in contact with the hand, and the user can hold the handle 1 with both hands at the same time, and the force applied is relatively more symmetrical.

Of course, the specific form of the holding part a can be adjusted according to the actual situation, it is not limited to this.

The function of the connecting part b is to detachably connect the holding part a and the ground inserting part c. In this embodiment, the connecting part b is a series of straight tubes, which is composed of two steel pipes as shown in FIG. 3, the two steel pipes are arranged side by side, and both ends of each hard steel pipe are processed into concave form. In actual processing, the two ends of the steel pipe can be flattened directly to form an arc surface 2, the two concave surfaces at the same end of the connecting part b are opposite to each other, forming a connection structure holding the T-shaped vertical tube or ground inserting part, the connection section of the holding part a or the ground inserting part c can be inserted between two arc surfaces for assembly and splicing. In order to ensure the stability of the connection, screw holes can also be opened on the arc surface 2, and screw holes can also be opened at the corresponding position of the holding part a or the ground inserting part c, which can be further tightened and fixed by bolts or screws and other connectors under the clamping of the two arc surfaces 2. The ends of the two steel pipes wrap the holding part a or the ground inserting part c from left to right and are connected together, such a design is conducive to the stable connection between the holding part a and the ground inserting part c, avoiding the shaking caused by other connection methods, making the assembled device aerating the lawn by perforating more stable and durable. Moreover, after use, the connector can be further removed to separate the three parts to facilitate storage and maintenance.

Of course, the structural form of the connecting part b can also be varied, in addition to the form composed of the above two steel pipes, the connecting part b can also adopt the connection way of the large pipe embracing the small pipe, a thick pipe is connected to the end of the holding part a and the ground inserting part c, and the connection is fixed by interference fit, snap connection, thread connection, etc.

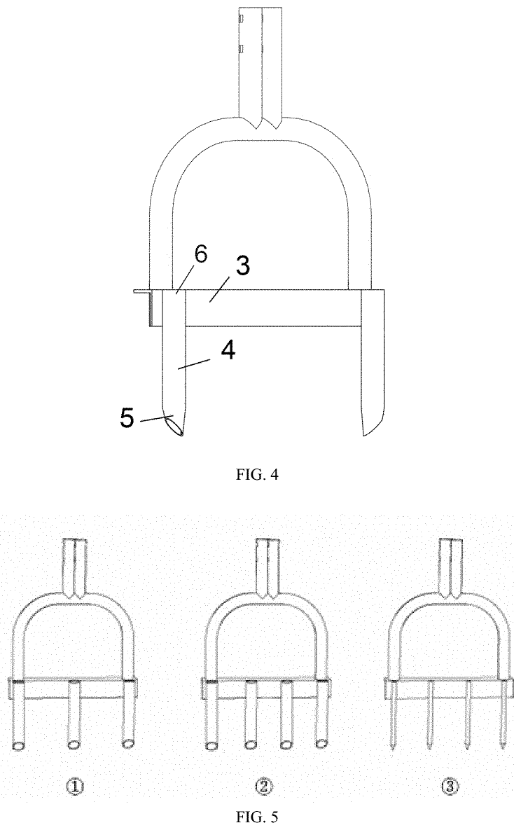

The ground inserting part is used for perforating the lawn under the action of down pressure. The perforating in the present invention is realized through plug 4, so at least one plug 4 is arranged on the ground inserting part c. As shown in FIG. 4, there are two plugs 4 on the ground inserting part c in this embodiment. The plug 4 is detachably connected with the connecting part b through the plug connecting frame and its forms can be adjusted by the upper holding part a, when the plug 4 is under downward pressure, it can be inserted into the lawn soil for perforating. In this embodiment, the plug 4 adopts hard hollow pipe structure with gradual diameter, the plug 4 can be made of steel pipe or rolled with sheet. The bottom of the steel pipe has an oblique incision 5 with a tip to facilitate insertion into the soil. The top of the hard hollow pipe is used as the soil outlet 6. When the plug 4 is pressed into the soil, the soil at the oblique incision 5 will gradually enter the steel pipe, and then move to the soil outlet 6. In the process of repeatedly pressing plug 4, the soil at the top of the steel pipe will constantly emerge from the outlet and fall on the surface of the lawn, which can prevent the plug from blocking while realizing the lawn perforating. Since the pipe diameter inside the plug 4 is generally not very large, in order to facilitate the soil falling off inside, the pipe diameter from the oblique incision 5 to the soil outlet 6 is designed to increase gradually, so that the soil will be separated from the inside of the steel pipe in the process of upward movement, reducing the friction between the two. The outer diameter of the steel pipe from the oblique incision 5 to the soil outlet 6 is also designed to increase gradually to allow easier insertion into the soil.

Furthermore, some lawn soil may be too hard to be inserted. The user's pressure on the holding part a alone may not be enough to insert the plug 4 into the soil. Therefore, a trodden part can be installed on the ground inserting part c to apply pressure on the plug 4. In this embodiment, the trodden part is a pedal 3 fixed on the plug connection frame, and the pedal 3 can be made of angle steel and other materials to ensure its strength. Of course, the trodden part is not necessarily a single fixed component, but can also be a convenient position for trampling on the ground inserting part c itself, for example, the plug connection frame in FIG. 4 can be provided with a bending part, and the user can directly apply pressure on the bending part.

In addition, generally considering the efficiency, two or more than two plugs 4 can be equipped in order to form a multiple holes to improve the work efficiency. However, too many plugs 4 will also cause the volume of the whole device to be too large, or the pressure required by a single perforating is too large, so the number of plug 4 set on the ground inserting part c can be increased or deleted according to needs. At the same time, the hollow plug 4 can be replaced by solid pointed spikes according to the actual demand, and two or more pointed spikes can also be provided.

Finally, in this embodiment, the holding part a, the connecting part b and the ground inserting part c are all made of steel, but other metal materials, plastics or other high-strength polymer materials can also be used, as long as they can meet the strength requirements for perforating.

The device aerates the soil by perforating the lawn, after perforating, the air can directly enter the depth of the soil and improve the internal environment, at the same time, the holes can also improve the loose degree of the surrounding lawn soil, so as to facilitate drainage and solve various problems caused by the hardening of the lawn soil.

The above embodiments are only a better scheme of the present invention, but they are not intended to limit the present invention. those having ordinary skills in the art may also make various changes and variations under the condition that they do not deviate from the spirit and scope of the present invention. Therefore, all technical solutions obtained by means of equivalent substitution or equivalent transformation fall within the protection scope of the present invention.

1. An assembled device aerating the lawn by perforating comprising:
a holding part (a) for the user to hold;
a connecting part (b), one end is detachably connected and fixed with the holding part (a), the other end is detachably connected and fixed with a ground inserting part (c);
a ground inserting part (c) is used for perforating the lawn under the action of down pressure, the ground inserting part (c) is provided with at least one plug (4), and the plug (4) is a hard hollow pipe, and the bottom of the hard hollow pipe is an oblique incision (5) with a tip, and the top of the plug (4) is provided with a soil outlet (6), the inner diameter of the hard hollow pipe gradually increases from the oblique incision (5) to the soil outlet (6).

2. An assembled device aerating the lawn by perforating according to claim 1, wherein the holding part (a) is a T-shaped tube composed of a series of horizontal tubes and a series of vertical tubes, and the connecting part (b) is a series of straight tubes.

3. An assembled device aerating the lawn by perforating according to claim 1, wherein detachable connection and fixing forms comprise snap connection, muff coupling, thread connection or connection through detachable connectors.

4. An assembled device aerating the lawn by perforating according to claim 1, wherein the connecting part (b) comprises two hard steel pipes side by side, and both ends of each hard steel pipe are processed into concave forms, and the two concave surfaces at the same end of the connecting part (b) are opposite to each other, forming a connection structure holding the holding part (a) or the connecting part (b).

5. An assembled device aerating the lawn by perforating according to claim 1, wherein the concave surface is provided with connecting holes for screwing into the connectors.

6. An assembled device aerating the lawn by perforating according to claim 1, wherein the ground inserting part (c) is provided with a trodden part for applying down pressure to the plug (4).

7. An assembled device aerating the lawn by perforating according to claim 1, wherein the trodden part is a pedal (3) made of angle steel.

8. An assembled device aerating the lawn by perforating according to claim 1, wherein the holding part (a), connecting part (b) and ground inserting part (c) are made of steel.

9. An assembled device aerating the lawn by perforating according to claim 1, wherein the ground inserting part (c) is provided with two or more plugs (4).
